(19) United States
(12) Patent Application Publication
(10) Pub. No.: US 2013/0218823 A1
(43) Pub. Date: Aug. 22, 2013

(54) METHOD AND SYSTEM FOR ANALYSING FLIGHT DATA RECORDED DURING A FLIGHT OF AN AIRCRAFT

(71) Applicant: Fabrice Ferrand, Leblanc (FR)

(72) Inventor: Fabrice Ferrand, Leblanc (FR)

(21) Appl. No.: 13/813,014

(22) PCT Filed: Jul. 19, 2011
(86) PCT No.: PCT/EP2011/062381

§ 371 Date: Mar. 18, 2013

(30) Foreign Application Priority Data
Jul. 29, 2010 (FR) 10/56273

(51) Int. Cl. G06N 5/02

(52) U.S. Cl. CPC G06N 5/02
USPC 706/46

(57) ABSTRACT

The present invention concerns a method for analysing a so-called first set of flight data, the values of which were recorded during a flight of an aircraft and in which at least one subset of flight data, comprising at least one of the flight data of the first set and/or at least one flight data item of a second set, provided that at least one of its data exceeds its nominal value, is defined by correlation of the value of at least one flight data item of the first set with the value of at least one of the flight data of the second set. A flight event is then able to be detected from the values of the flight data of a subset and the values of the flight data of one of the second sets of flight data and, if a flight event is not detected from a subset, a probability of pairing between at least one second set and this subset is associated with this subset, the first set is then updated by adding at least one new flight data item of at least one second set and/or by deleting at least one of its flight data, according to the pairing probability values, the first set of flight data thus updated is then once again recorded during a new flight, and the method is iterated as long as an expert cannot make a decision on this subset.

The present invention concerns a method and system for analysing a set of flight data the values of which have been recorded during a flight of an aircraft.

One of the main causes of delays with aircraft is related to technical problems occurring on these aircraft unexpectedly. In addition, the maintenance phases for these aircraft requiring prolonged immobilisation thereof are very often restricted to the minimum for reasons of profitability.

The regulations in terms of maintenance and travel in the air define standards that operators are obliged to comply with in order to ensure a maximum safety level for users.

However, it has been observed that, in the past years, flight safety is stagnating. In order to continue to increase flight safety despite the continuous increase in air traffic and to optimise the maintenance phases, airlines have equipped themselves with flight data analysis systems.

These systems enable airlines to understand in detail the events on a flight from regular recordings of the values of these flight data effected during each flight of each of their aircraft.

For this purpose, these systems detect singular events occurring during a flight. An expert then analyses these events, which indicate that a technical incident has occurred during a flight, or that a practice or condition expected by a flight procedure has not been complied with, thus warning at a very future stage of possible incidents or accidents that could occur.

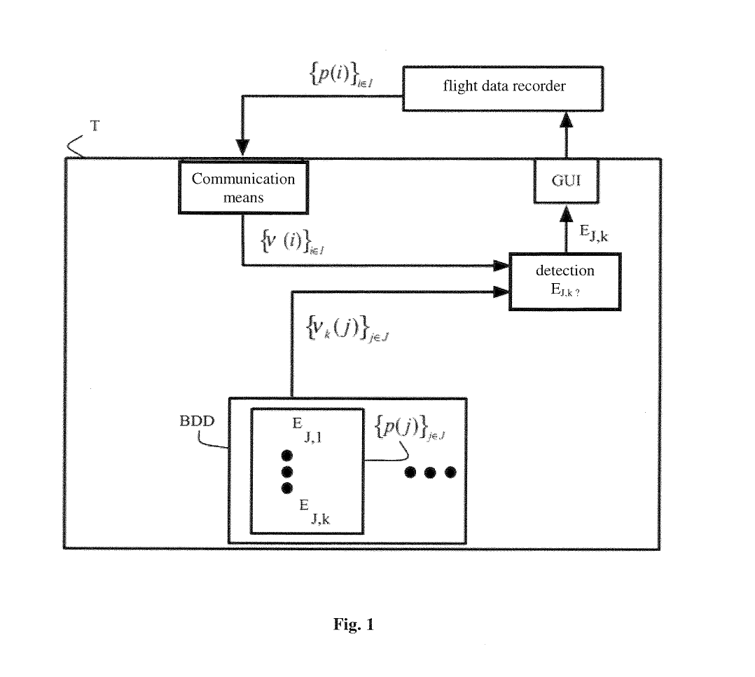

FIG. 1 shows schematically a system known as FDM (Flight Data Monitoring) which makes it possible to analyse a set of flight data {p(i)}_{iεI} with I ⊂ D and D the whole of the flight data indices, the values of which {v (i)}_{iεI} are recorded during an aircraft flight.

The principle of the system consists in equipping the aircraft with means of recording these values {v (i)}_{iεI}. These means are, for example, a black box or specific recorders such as ACMSs (Aircraft Condition Monitoring Systems). These flight data {p(i)}_{iεI} (and therefore their values) are in many forms. For example, a value of a flight data item may be a measurement, possibly multidimensional, or a flight parameter (pressure of a fluid, air speed, vibration frequency, etc.) or represents an occurrence of an action performed by the personnel on board (activation of the automatic pilot, etc.).

When the aircraft has ended its flight or when it is stopped over in an airport, the values {p(i)}_{iεI} are recovered by a processing unit T via cabled or wireless communication means and analysed by a data-mining algorithm.

For this purpose, an expert determines and records in advance in a database BDD sets of flight data {p(j)}_{jεJ} with J ⊂ D and a set of flight events E_{J,k} relating to each flight set {p(j)}_{jεJ}. Each flight event E_{J,k} relating to a set J of flight data {p(j)}_{jεJ} corresponds to the values {vₖ(j)}_{jεJ} of this set that were recorded during a previous flight (k designates for example an instruction to record values {vₖ(j)}_{jεJ}) in the database and subject to the constraint that the value vₖ(m) of at least one of these flight data {p(m)}_{mεJ} exceeds its nominal value Lₘ, which is also prerecorded and is established so as to comply with current regulations on air safety and the flight procedures particular to each airline. In mathematical terms, E_{J,k}={vₖ(j)_{jεJ}|vₖ(j)>Lⱼ≠φ} or E_{J,k} is the non-empty set of {vₖ(j)}_{jεJ} such that vₖ(j) is greater than the nominal threshold value Lⱼ, that is to say there exists at least one flight data value that is not nominal. This implies that there exists an order relationship associated with the data item J that makes it possible to write vₖ(j)>Lⱼ. This relationship may be different for each flight data item and is not necessarily defined by the operator of comparison of two integers.

Once the expert has determined and stored these various sets of flight data and the flight events that are associated therewith, he defines means, normally in the form of computer programs, for these events E_{J,k} to be detected following the recording during a flight of an aircraft of the values {v (i)}_{iεI} of a set of flight data {p(i)}_{iεI}. The context in which a flight event has occurred may also be recorded. For example, the context may be the denomination of the sensor that recorded a flight data item, or the location of an aircraft at the time of this recording, etc.

Through these means, the algorithm then detects an event E_{J,k} if there exists at least one value {v (i)}_{iεI} of a flight data item of the set of flight data {p(i)}_{iεI} that exceeds a nominal value and if this flight data item corresponds to a value {vₖ(j)}_{jεJ} of a flight data item of a set of flight data {p(j)}_{jεJ} previously recorded in the database BDD. It is therefore a case of finding J and k such that I=J with I associated with a known singular flight event and k an occurrence of E_{J,k} in the recording of the data effected up until the present.

The processing unit T also normally calculates statistics on the values of the sets of flight data recorded during several flights of the same aircraft and/or on the various flight events that have been detected. The processing unit T then derives therefrom the trends concerning the change over time in these flight data and/or flight events. These trends evaluate whether a risk is increasing or decreasing. For example, a value of a flight data item recorded during a flight may also be recorded during future flights and, at the end of a certain number of flights, a diagram of the change over time in this flight data item can be established.

The system also comprises graphical means GUI for presenting to an expert these various flight events and other trends. These representations sometimes take the appearance of tables in which there are indicated the data of a flight or several flights, the exceeding of nominal values and other time diagrams representing the flight data trends and other changes in flight events.

The expert then analyses these representations in order to validate whether the flight events detected following the analysis of the values {v(i)}_{iεI} do indeed correspond to a flight incident in order to precisely retrace the progress of the flight and/or the change in trends.

He then derives therefrom relationships between flight events that have occurred during a flight or several flights of an aircraft and consequently predicts an action to be undertaken to prevent these flight events recurring or a major incident requiring immobilisation of the aircraft. He may for example provide for maintenance of the aircraft and/or a possible modification in a flight procedure and/or specific training of the onboard personnel. For this purpose, the graphical means GUI enable the expert to modify or manually enter new sets of flight data to be recorded and/or new flight events and/or new nominal values.

The airlines have equipped their aircraft with a multitude of sensors so as to record a maximum amount of flight data, considering that, the more flight data values the expert has available and the more anodyne situations are recorded in the database, that is to say the more flight events that will be detected, the more the expert will be able to precisely evaluate the flight situations that led to these events and thus predict for the future a large number of major incidents or future accidents.

Moreover, regulations on flight safety change (consequences of accidents, energy or economic efficiency, taking account of increases in traffic, etc.) and regularly require new flight events to be taken into account. This results in a change both in the flight recording means and the means for detecting these new flight events. Likewise, an airline may add or modify his own flight events for the purpose of further improving flight safety and optimising its procedures.

Although in theory increasing the number of flight data recordings and sets of flight data to be recorded increases the precision and relevance of expertise in flight situations, in practice the systematic analysis by the expert of all the flight events detected involves significant resources, both in terms of computing power necessary for the analysis of the flight data values by the processing unit T and in terms of workload for the expert. Generally, only the sets of flight data and other flight events required by the air safety regulations and the airline procedures are analysed.

These experts therefore forge their flight situation evaluations only using a very small number of flight events that were prerecorded in the database BDD and which represent only a small part of the flight events that could be detected from the flight data values recorded during an aircraft flight. However, some of these “non-recorded” flight events, apparently minor in the eyes of the expert, could allow the detection of underlying future problems that do not appear in their assessment reports because of their non-systematic analysis of all the flight data values recorded.

Current analysis of a set of flight data recorded during an aircraft flight therefore enables an expert to compare flight events and/or trends for identical flight conditions (same aircraft, same flight plan) whereas it would be advantageous for the expert to be able also to have access equally to all the flight events detectable from the flight data values recorded, that is to say among other things to flight events that have occurred under flight conditions similar to those in which a flight event recorded in the database BDD has already occurred.

Such a system would then make it possible to enrich the database BDD of flight data recorded by the various aircraft of an airline, or even several airlines, thus increasing the probability that a flight event has already occurred and therefore increase the detectability thereof. Such a system would thus have the possibility of enriching and improving the detections of new flight events not predicted by the expert.

Such a flight data analysis system would then afford a significant alleviation of the workload of the expert, who would no longer have to cross check flight conditions in order to determine whether flight conditions are similar, and an airline would then have a view of the risks incurred by all the aircrafts in its fleet without the expert having a significant increase in his workload.

Another drawback of the use of current data-mining algorithms is that the flight events newly determined by an expert are recorded manually by this expert, by graphical means GUI. It would be very advantageous for the system to automatically generate new flight events or even new sets of flight data following its own analysis of the flight data value recorded. The intervention of an expert would then be required only to validate any conflicts between the events and/or or sets of flight data.

The problem solved by the present invention is determining a flight data analysis system that remedies the aforementioned drawbacks.

To this end, in general terms, the present invention concerns a method for analysing a so-called first set of flight data, the values of which were recorded during an aircraft flight and in which a flight event is detected when the flight data values of the first set and the flight data values of another set of flight data, referred to as the second set, which were recorded during a previous flight, are values relating to the same flight data and if the same flight data values of the first set and the second set exceed their respective nominal values.

According to one feature, at least one flight data subset comprising at least one of the flight data of the first set and/or at least one flight data item of a second set, provided that at least one of its data exceeds its nominal value, is defined by correlating the value of at least one flight data item in the first set with the value of at least one of the flight data in the second set. In addition, a flight event is then able to be detected from the flight data values of a subset and the flight data values of one of the second flight data sets, and, if a flight event is not detected from a subset, a probability of matching between at least a second set and this subset is associated with this subset, the first set is then updated by adding at least one new flight data item of at least a second set and/or by omitting at least one of its flight data, and this according to the pairing probability values. The first flight data set thus updated is then once again recorded during a new flight, and the method is iterated as long as a maintenance or flight safety expert cannot take a decision on this subset.

This method enriches the initial knowledge of a database consisting of a predefined set of flight events liable to occur.

This is because, by virtue of the automatic determination of correlations between the flight data values previously recorded and the flight data values to be analysed, new flight data sets (or subsets) are generated by the method, which results in the possible detection of new flight events that an expert had not initially predicted.

According to a variant, each subset is presented to an expert. If the expert decides that a subset is preponderant, this subset is stored and, if he decides that a subset is a false alarm, this subset is no longer considered.

This presentation of the subsets enables an expert to decide on the relevance of the flight events relating to these subsets so that only flight events that are relevant with regard to the safety of future flights or relate to the change in a flight procedure of an airline are added to the system.

According to one embodiment, at least one new flight data item that is added to the first set comes from the second set, which maximises the probability of matching with a subset.

This method is advantageous since it optimises the chances that the expert can pronounce on the relevance of a subset as from the next recording of the new flight data set thus modified.

According to one embodiment, the probabilities of pairing are recorded and updated at each iteration of the method, and the second sets, from which said at least one new flight data item is obtained for updating the first set, are selected from the variation over time in their pairing probabilities.

Analysing the flight data values in the first set thus makes it possible to identify the variation in the flight data sets recorded during several successive flights, in order to take into account changes in flight conditions but also any modifications to the flight procedures and/or the air safety regulations that are introduced by an expert.

According to a variant, the flight event detection is also updated when the first set is updated so that this detection can detect a flight event relating to said subset.

This variant is advantageous since it enables flight events defined from subsets to be detected in the future, even if these events could not be detected up until then.

According to a variant of this variant, simulated flight data are used to validate the modifications to the event detection thus modified.

These flight data make it possible to validate the functioning of the system once the detection of events is updated, that is to say, among other things, to validate that the events detected up until then are still detected, that false results are not occurring with respect to the nominal values, or that the values at the limits are reached, etc.

The present invention also concerns an analysis system that comprises means for implementing one of the above methods.

The features of the invention mentioned above, as well as others, will emerge more clearly from a reading of the following description of an example embodiment, said description being given in relation to the accompanying drawings, among which:

FIG. 1 shows schematically a system for analysing a flight data set the values of which were recorded during a flight of an aircraft, and

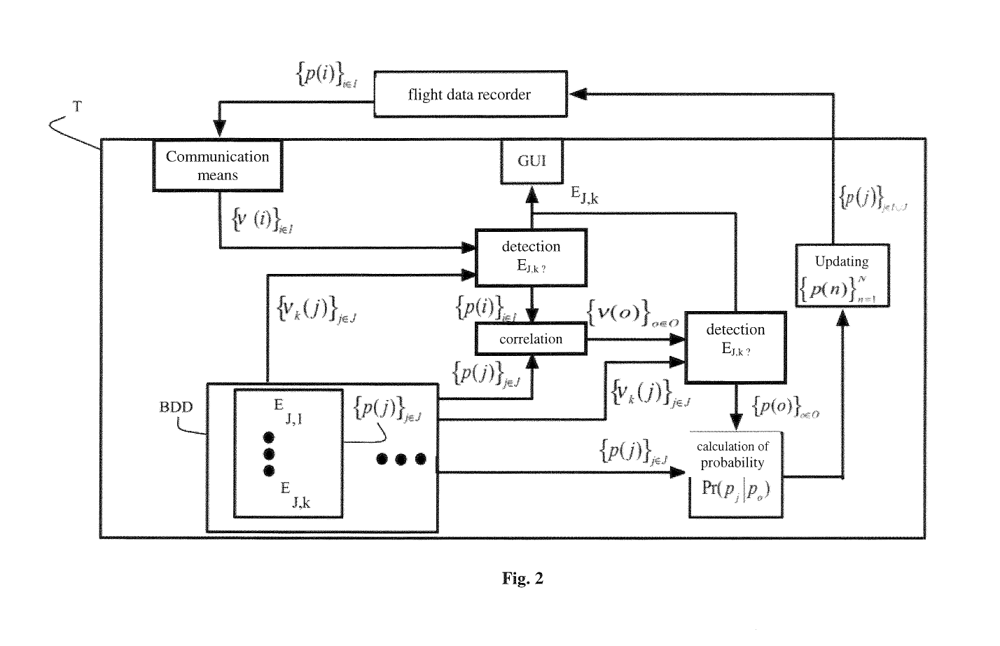

FIG. 2 shows schematically a system for analysing a set of flight data {p(i)}_{iεI} the values of which were recorded during a flight of an aircraft according to the present invention.

The references in FIG. 2 that are identical to those in FIG. 1 represent the same elements.

The analysis system of FIG. 2 comprises a processing unit T that contains means for detecting a flight event (E_{J,k}) when the values of the flight data in the set {p(i)}_{iεI} and the values {vₖ(j)}_{jεJ} of the flight data of a set of flight data {p(j)}_{jεJ}, which were recorded during a previous flight, are values relating to the same flight data and, if the same values vₖ(m)_{mεJ} of the flight data in the set {p(i)}_{iεI} and the set {p(j)}_{jεJ} exceed their respective nominal values.

In practice, the database BDD comprises several sets{p(j)}_{jεJ}.

The processing unit T also comprises means for defining at least one subset of flight data {p(o)}_{oεO} that comprises at least one of the flight data in the set {p(i)}_{iεI} and/or at least one flight data item in a set {p(j)}_{jεJ} provided that at least one of its data items exceeds its nominal value, by correlation of the value {v (i)}_{iεI} of at least one flight data item in the set {p(i)}_{iεI} with the value {vₖ (j)}_{jεJ} of at least one of the flight data in the set {p(j)}_{jεJ}.

The processing unit T also comprises means for determining and associating with each subset {p(o)}_{oεO} a probability of pairing Pr(pₒ|pⱼ) between at least one set {p(j)}_{jεJ} and this subset {p(o)}_{oεO}, and means for updating the set {p(i)}_{iεI} by adding at least one new flight data item {p(n)}_{nεN} (N ⊂ D) of at least one set {p(j)}_{jεJ} and/or by deleting at least one of its flight data items {p(i)}_{iεI}, according to the pairing probability values Pr(pⱼ|pₒ).

The means of the processing unit T are implemented, according to one embodiment, in the form of computer programs.

The analysis method used by such a processing unit T makes it possible to analyse the values of the set of flight data {p(i)}_{iεI} that is not necessarily known previously from the database BDD. Thus it makes it possible to minimise the task of an expert for comparing new flight events issuing from this set of flight data to be analysed with the flight events E_{J,k} previously recorded in the database BDD.

This method is iterative and implements a method that can be assimilated to an analysis that is multidimensional and parameterised by unsupervised learning.

First of all, at least one flight data subset, comprising at least one of the flight data items in the set {p(i)}_{iεI} and/or at least one flight data item in a set {p(j)}_{jεJ}, provided that at least one of its data exceeds it nominal value, is defined by the correlation of the value {v (i)}_{iεI} of at least one flight data item in the set{p(i)}_{iεI} with the value {vₖ(j)}_{jεJ} of at least one of the flight data of a set {p(j)}_{jεJ}.

The sets I and J are any sets in the set D of all the flight data and no assumption of relationship between them exists. Thus the sets I and J may have an empty or non-empty intersection, I (or respectively J) can be included in J (or respectively I).

Defining the correlation between values of the flight data of the set {p(i)}_{iεI} and values of the flight data of the set {p(j)}_{jεJ} is within the capability of a person skilled in the art. For example, a set of rules can be pre-programmed so that some flight data systematically form a subset as soon as they are present in the two sets and others can be separated as soon as they are either in one or other set. It is also possible to establish rules for quantifying the correlation between the values and to form subsets only with the flight data that have high correlation values.

Once one or even several subsets have thus been formed, a flight event E_{J,k} is then able to be detected from the values of the flight data {v(o)}_{oεO} of a subset {p(o)}_{oεO} and the values {vₖ(j)}_{jεJ} of the flight data of one of the sets of flight data {p(j)}_{jεJ}. An event E_{J,k} is detected if {v(o)}_{oεO} and {vₖ(j)}_{jεJ} of a set {p(j)}_{jεJ} are values relating to the same flight data (I=J in particular) and if {v(o)}_{oεO} and {vₖ(j)}_{jεJ} exceed their respective nominal values.

This case corresponds to the detection of a flight event that has already occurred during a previous flight.

If on the other hand a flight event that occurred previously is not detected from a subset, then a probability of pairing Pr(pₒ|pⱼ) between at least one set {p(j)}_{jεJ} and this subset is associated with this subset.

According to one embodiment, the estimation of these probabilities Pr(pₒ|pⱼ) can be seen as a direct problem of classification of each subset issuing from the set {p(i)}_{iεI}. Considering then each set {p(j)}_{jεJ} as classes of events that group together the flight events that are detected by these sets of flight data, and that the set {p(i)}_{iεI} consists of a plurality of subsets independent of one another, the direct problem for classifying the subsets is expressed by

$$y = arg max {\prod }_{o = 1}^{O} P ( {p}_{o} \vert {p}_{j} )$$

with y an estimation of the classification of all the subsets pₒ in the classes pⱼ.

For solving this problem, the use of a classification method known as Cauchy/Naive/Bayes is known, which was widely used in the field of the classification of image primitives (Emotion Recognition using a Cauchy Naive Bayes Classifier, IEEE Transactions on Pattern Analysis and Machine Intelligence, 18(6):636-642, 1996).

This method is iterative and makes it possible to converge towards a classification of the subsets that is stable. At this moment, each of the probabilities Pr(pₒ|pⱼ) is fixed at a value that is high when the subset and the set pₒ have a large number of flight data in common.

The set {p(i)}_{iεI} to be analysed is then updated by adding at least one new flight data item {p(n)}_{nεN} of at least one set {p(j)}_{jεJ} and/or by omitting at least one of its flight data {p(i)}_{iεI}, according to the pairing probability values Pr(pⱼ|pₒ).

Thus, as the pairing probability quantifies the resemblance between the set {p(j)}_{jεJ} and each subset, the N flight data {p(n)}_{nεN} of the set {p(j)}_{jεj} chosen can be added to the set {p(i)}_{iεI}, which will then make it possible, during future recordings of these flight data values {p (j)}_{jεI∪J}, to provide indications that enable an expert to make a decision as to how to deal with the subset.

In the case where several subsets are formed, at the end of the calculation of the probabilities, the N flight data {p(n)} _{nεN} added depend on the results of all the probabilities.

The set of flight data thus updated {p(j)}_{jεI∪J} is then once again recorded during a new flight, and the method is iterated as long as an expert cannot make a decision on this subset.

The addition of new flight data is a kind of dynamic programming of the flight recorders that maximises the probability of detection of new events but also the probability of detection of an event well before a problem or a fault occurs during the flight of an aircraft.

According to a variant, each subset is presented to an expert via the graphical means GUI. The expert can then decide whether this subset is a preponderant flight event. If such is the case, this subset is stored in the database BDD and then enriches the system of this new flight event. If he decides that a subset is a false alarm, this subset is no longer considered.

According to one embodiment, at least one new flight data item {p(n)}_{nεN} that is added to the set {p(i)}_{iεI} comes from the set {p(j)}_{jεJ} that maximises the probability of pairing with a subset.

According to one embodiment, the pairing probabilities Pr(pⱼ|pₒ) are recorded and updated at each iteration of the method, and the sets {p(j)}_{jεJ}, from which said at least one new flight data item {p(n)}_{nεN} is obtained for updating the set {p(i)}_{iεI} are selected from the variation over time of their pairing probabilities.

According to a variant, the detection of a flight event is also updated when the set {p(i)}_{iεI} is updated so that the detection means can detect a flight event relating to a subset.

Advantageously, simulated flight data are used for validating the modifications of the modified event detection.

1) A method for analysis by a processing device, a first set of flight data ({p(i)}_{iEI}) the values ({v (i)}_{ieI}) of which were recorded during a flight of an aircraft, the second sets of flight data that were recorded during previous flights being stored in a database, the method being such that an event of flight (E_{J,k}) is detected when the values of the flight data of the first set of flight data ({p(i)}_{iEI}) and the values ({vₖ(j)}_{jEI}) of the flight data of one of said second sets of flight data ({p(j)}_{jEJ}) are values relating to the same flight data and if the same values (vₖ(m)_{mEJ}) of the flight data of the first set and the second set exceed respective nominal values,
characterized in that the processing device performs steps such that:
a subset of flight data ({p(o)}_{oEO}) is defined so that it comprises at least one of the flight data of the first set ({p(i)}_{iEI}) and at least one flight data item of one of said second sets ({p (j)}_{jeJ}), at least one of which exceeds its nominal value, and so that there exists a correlation of the value ({v (i)_{iEI})) of this or these flight data of said first set ({p(i)}_{iEI}) with the value ({vₖ (j)_{jEJ})) of this or these flight data of said second set ({p(j)}_{jEJ}), and
a flight event of flight (E_{J,k}) is then able to be detected from the values of the flight data of said subset of flight data ({p(o)}_{oEO}) and values (vₖ (j)}_{jEJ}) of the flight data of one of the second data sets of flight data ({p(j)}_{jEJ}), and
if a flight event is not detected from said subset of flight data,
a probability value matching (Pr(pₒ|pⱼ)) between at least one of second sets of flight data ({p(j)}_{jEJ}) and said subset of flight data ((p (o)}_{oEO}) is associated with said subset of flight data,
the first set of flight data ({p(i)}_{iEI}) is then updated by adding at least one new flight data ({p(n)}_{nEN}) of at least one of said second sets of flight data ({p (j)}_{jEJ}) and/or by deleting at least one of its said flight data ({p(i)}_{iEI}) according to the pairing probability values or values (Pr (pⱼ|pₒ)).

2) A method according to claim 1, in which said subset is presented to an expert via a graphical interface, to enable the expert to decide whether said subset is preponderant and must be stored by the processing device or whether is corresponds to a false alarm and must not be considered further.

3) A method according to claim 1, in which at least one new flight data item (p {(n)}_{nEN}) that is added to the first set of flight data ({p(i)}_{iEI}) comes from the set among said second sets of flight data {p (j)}_{jEJ}), that maximizes the pairing probability with said subset ({p(o)}_{oEO})

4) A method according to claim 1, in which the pairing probability values or values (Pr (pⱼ|pₒ)) are recorded and updated in each iteration of the method, and the second sets flight data ({p(j)}_{jeJ}), from which said at least one new flight data (p {(n)_{nEN}}) is obtained for updating the first set of flight data ({p(i)}_{ieL}, are selected using the variation over time of their pairing probability.

5) Method according to claim 1, in which the flight event detection is updated when the first set of flight data is updated so that this detection can detect a flight event relating to said subset of flight data.

6) Method according to claim 5, in which the simulated flight data are used to validate the updating of the event detection.

7) System for analyzing a first set of flight data ({p(i)}_{jeJ}) the values ({v (i)}_{ieI}) of which were recorded during a flight of an aircraft, said system comprising a database (BDD) in which second sets of flight data ({p(j)}_{jeJ}) recorded during the previous flights are stored, and means for detecting a flight event (E_{Jk}) when the values of the flight data of the first set of flight data ({p(i)}_{jEJ}) and the values ({vₖ (j)}_{jEJ}) of the flight data of one of said second sets of flight data ({p(j)}_{jEJ}) are values relating to the same flight data and if the same values (vₖ(m)_{MEJ}) of the flight data of the first set of flight data ({p(i)}_{iEI}) and of the second set of flight data ({p(j)}_{jEJ}) exceed respective nominal values (Lₘ),
characterized in that it also comprises:
means for defining a subset of flight data ({p(o)}_{oEO}), so that it comprises at least one of the flight data of the first set of flight data ({p(i)}_{iEI}) and at least one flight data item of one of said second sets of flight data ({p(j)}_{jEJ}), at least one of which exceeds its nominal value, and so that there exists a correlation of the value ({v(i)}_{ieI}) of this or these flight data of said first set ({p(i)}_{iEI}) with the value ({vₖ (j)}_{jEJ}) of this or these flight data of said second set ({p (j)}_{IEJ}), and
means for determining, and associating with said subset of flight data ({p(o)}_{oEO}), a probability value of pairing (Pr (pₒ|pⱼ)) between at least one of said second sets of flight data ({p(j)}_{jEJ}) and the subset of flight data ({p(o)}_{oEO}), and
means for updating the first set of flight data ({p(i)}_{iEI}) by adding at least one new flight data item (p{(n)}_{nEN}) of at least one of said second sets of flight data ({p(j)}_{jEJ}) and/or by deleting at least one of its flight data items ({p(i)}_{/iEI}), according to the pairing probability value or values of (Pr (pⱼ|pₒ)).
